(19) United States
(12) Patent Application Publication
(10) Pub. No.: US 2004/0106844 A1
(43) Pub. Date: Jun. 3, 2004

(54) Incubator for newborn and prematurely born patients

(76) Inventor: Torsten Lonneker-Lammers, Hamburg (DE)

Correspondence Address: ALIX YALE & RISTAS LLP, 750 MAIN STREET, SUITE 1400, HARTFORD, CT, 06103, US

(21) Appl. No.: 10/474,016

(22) PCT Filed: Apr. 12, 2002
(86) PCT No.: PCT/EP02/04094

(30) Foreign Application Priority Data
Apr. 12, 2001 (EP) 01 109 195.6

(51) Int. Cl. A61G 11/00

(52) U.S. Cl. 600/22

(57) ABSTRACT

The inventive incubator for newborn and prematurely born patients, which can be introduced into the magnetic field of an NMR tomograph, is characterized in that the devices for the supply and circulation of fresh air, for heating and humidifying the air, for controlling the temperature thereof and for examining the patient are electrically driven and integrated into the incubator. The circulation of air in the room provided for the patient has one component extending in the longitudinal direction of the incubator and one or two components extending in a roller-type manner about the longitudinal axis.

The invention relates to an incubator for newborn and premature patients which can be introduced into the magnetic field of an NMRI tomograph.

Premature babies and newborn babies are often unable to independently maintain their body temperature. They are therefore kept warm in what are called incubators. These are generally of a considerable size and contain metal parts, in particular iron parts. Such incubators cannot therefore be introduced into the magnetic field of an NMRI tomograph, so that, even though desirable, it is not possible to examine the patient by NMRI while he/she is in the incubator.

An incubator is in fact known with which the patient can be introduced into the magnetic field of the NMRI tomograph (DE 196 17 739 C1). However, said incubator is of a relatively simple design and, for example, has no devices for examining the patient, in particular no coil with which the magnetic resonance signals can be picked up. In addition, said incubator requires a pressure fluid source to operate the ejector for the air circulation and external gas canisters. The incubator is therefore difficult to transport.

An incubator of the type mentioned at the outset (WO 98/48756) does have devices for examining the patient, for example a coil for the magnetic resonance signals.

However, the incubator is connected via a plurality of cables and tube lines to a base unit which must be arranged away from the magnetic field, and for this reason it is again very difficult to transport. If an NMR image of the patient is to be taken, this involves the complicated task of bringing the base unit and the incubator to the NMRI tomograph.

A known incubator has a specially designed type of air flow and regulation of this flow, and also of the temperature (U.S. Pat. No. 5,730,355). However, said incubator is obviously not designed for introduction into an NMRI tomograph, so that problems from interaction with the magnetic field and the measurement electronics of an NMRI tomograph cannot arise.

Because of the problems that electric motors and electronic circuits could, on the one hand, have their function disrupted by the magnetic field and could, on the other hand, emit signals which interfere with the signals recorded in the NMRI tomography, it has hitherto been considered necessary to provide the electrical control means and electrical drive mechanism for fans and the like, for example, in a separate structural component (EP 0 864 295 A2). Moreover, because these incubators had to be made small, it was hitherto not possible to satisfactorily solve the problem of uniform heat distribution within the patient space. In one of the previously known incubators (DE 196 17 739 C1), there is indeed an effective circulation of air in the double-walled patient-receiving space. However, the small cross section means that, during use with a patient, a uniform distribution of heat and air flow is no longer ensured, which can lead to considerable problems. In the other previously known incubator (WO 98/48756), it is not at all clear how effective the air circulation and replenishment is intended to be and how it is designed.

The object of the invention is to make available an incubator which is suitable for NMRI tomography, is easy to transport and, despite its small size, permits a uniform temperature distribution and, consequently, effective and gentle heating/temperature maintenance of the patient.

The solution according to the invention is an incubator of the type mentioned at the outset, with devices for delivery and circulation of fresh air and a drive mechanism for these devices, and with devices for heating and humidifying the air, for regulating the temperature of said air, and for examining the patient, in which incubator said devices are driven electrically and are arranged integrally on the incubator, and the air movement in the patient space has a component extending in the longitudinal direction of the incubator and a component extending in a cylindrical formation about the longitudinal axis.

According to the invention, therefore, the belief that electrically driven devices cannot be arranged directly on the incubator has been disproven. Thus, for example, the fan no longer needs to be driven by a pressure fluid which is generated separately from the incubator. Instead, it can be driven electrically by a motor which is arranged on the incubator. The patient space is constantly permeated with air which flows in along one entire longitudinal side and forms a cylinder of air about the longitudinal axis of the incubator, and the air is once again suctioned off, on this axis, at one end of the patient space.

The electrical and electronic equipment is configured in such a way that, on the one hand, the measurement results, in particular the signals for the imaging, are influenced to the least possible extent, while, on the other hand, the energy emitted by the tomograph, and its magnetic field, has at the very most a minimal influence on the electrical and electronic equipment of the incubator. In the imaging, the signal/noise ratio and uniformity are important, and interferences caused by shadow images and geometric distortions have to be avoided. Furthermore, the incubator's performance data must not be negatively affected, for example the measurement accuracy and operating stability in the case of processor systems.

These aims are achieved by the combination of different measures, which combination then has the surprising result that all devices for effective functioning of the incubator can be arranged directly on said incubator, with the result that the latter can be easily transported.

For effective screening, all electrical components are incorporated throughout in protective casings providing good electrical conduction. For example, it is possible to use housings made of aluminum, sheathed lines and cables. Housing apertures, for example for displays, are provided with a metallic braid or metallized foil. Unused connections are covered so as to be EMC-compliant. It is important here that the screening is effected throughout.

All housing parts must be well grounded and jointly applied to ground potential. A star-shaped connection of the housing parts is important here; in any event, loops must be avoided in the conductor routing.

The electrical signals have to be filtered, and this applies both to the sensors and to the actuators, which are managed by the control system. Accordingly, a decision is made between sensor signals (temperature, humidity, response contacts) and actuation signals (control of heat elements, motors). Suitable filter topologies and filter components are chosen depending on the differentiation. A connection line between two components can be connected to ground via a capacitive filter (capacitor) in order thereby to ground high-frequency signals. Moreover, two components can be connected via a parallel circuit of a capacitor and an inductor, i.e. a suppressor circuit (throttle with small shunt capacitance). This gives a high suppression effect for high outputs/voltages. No current is led off to ground. The components should be of a high quality into the 100 MHz range. Air coils and chip capacitors should be used. For very high demands, an exact balance can be effected by means of a network analyzer.

Finally, ferromagnetic components should be avoided. The use of piezo technology is advisable for switches and drives. A band limit of the processor system (bus, data transfer) is also advisable.

Air is expediently delivered through a channel into a stabilizing space below the lying surface for the patient. After overcoming a flow resistance, the air can then pass with acceleration into the patient space, at a point to the side of the patient, so that the air movement mentioned above takes place. Since the devices of the incubator are electrically driven, an electrical connection simply has to be interrupted and then restored in order to transport the incubator. A transport carriage for the incubator could easily be provided with an accumulator ensuring operation of the incubator for at least 30 minutes. The supply of heated fresh air to the patient is therefore interrupted for only a very short time when changing location.

In many cases, it is necessary to supply the patient not just with air, but also with oxygen-enriched air. It is also possible to enrich the air with pure oxygen. In an expedient embodiment, the enrichment with oxygen is automatically regulated in accordance with a set value and monitored.

In an advantageous embodiment, not only is the air temperature regulated, but also the air humidity.

The measurement coil for the NMRI tomography could be arranged in the tomograph in such a way that the incubator has to be pushed into this measurement coil.

In a particularly expedient embodiment, however, the measurement coil for the NMRI tomography is arranged in the patient space. In an expedient embodiment, the measurement coil can be adjustable relative to the patient so that different body parts of the patient can be examined. The coil suitable for the particular examination can be inserted through a hatch on the rear face of the incubator.

The monitoring of the oxygen concentration in the incubator provides no information on the status of the patient. In addition, oxygen sensors interfere with the imaging. For this reason, SpO₂ measurement is possible for monitoring the patient. The incubator is expediently controlled by a microprocessor.

The end faces of the patient space are expediently provided with passages for ventilation lines, anesthesia lines and infusion lines and/or other lines and for the signal cable of the measurement coil.

To ensure that the electronics and the motors are not disturbed by the magnetic field or that these electrical and electronic components do not interfere with the measurement, the electronics are screened off in a suitable way. The voltage for the electronics is supplied using a specially screened switched-mode power supply unit, while the power elements (heater, humidifier) are supplied directly with line voltage via a semiconductor relay with the aid of pulse pause modulation. The whole incubator is regulated with the aid of a real-time operating system and a special software program and, in the event of deviations from the set values, a visual and/or acoustic alarm is emitted as appropriate. The screening and mechanical structure of the apparatus are such that the incubator is suitable using appropriate variants both for open and for closed tomographs with magnetic fields of 0.2 to 3 tesla. In addition, the incubator is configured so that it can be carried by two persons and can be moved from a suitable trolley onto the patient support of the tomograph in the tomograph space. The trolley carries the electrical power source in the form of an accumulator. If the patient is to be supplied not just with air, but also with oxygen, the corresponding gas canisters are of course also located on the trolley.

The parameters are expediently displayed and set digitally. The relevant international standards for medical appliances are of course also satisfied. Moreover, provision will preferably be made for the fresh air to be delivered through suitable filters, in particular particle filters, in order to avoid contamination of the respiratory air for the patient. As far as is possible, ferromagnetic materials will be avoided not just for the incubator, but also for accessory components. Magnetic materials will also be avoided in the trolley and in the other components such as the power and gas supply. Apertures and fixtures for accessories, for example monitors or ventilation devices, can likewise be provided in the incubator according to the invention.

The invention is described below on the basis of advantageous embodiments and with reference to the attached drawings, in which:

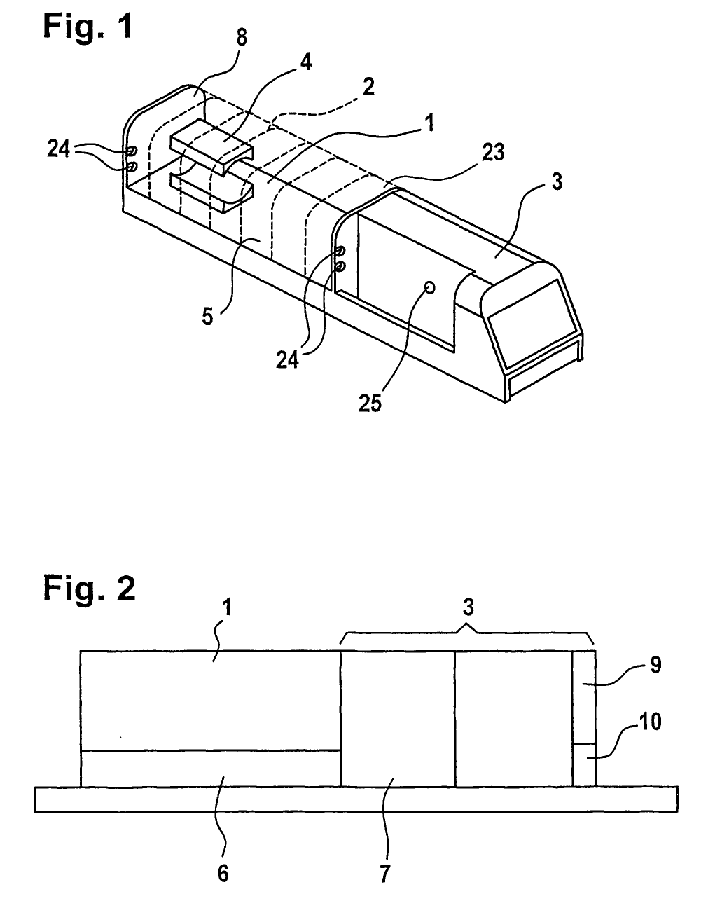

FIG. 1 shows, in a perspective view, a first embodiment of the incubator according to the invention;

FIG. 2 shows a diagrammatic view of the arrangement of the various components of the incubator according to the invention;

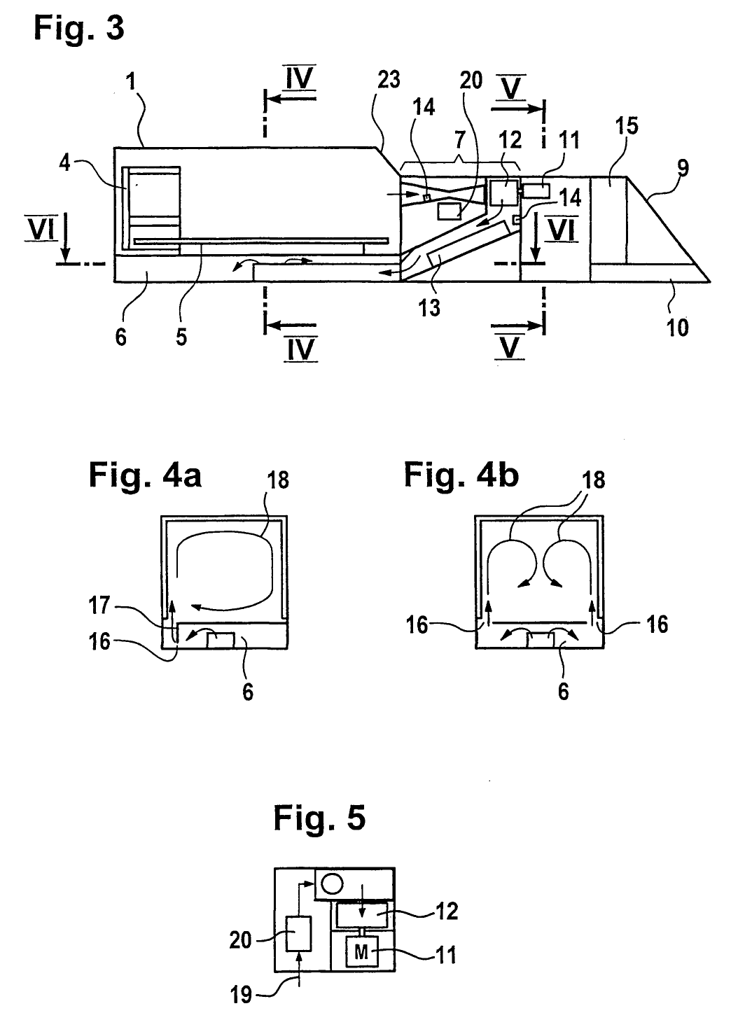

FIG. 3 shows a longitudinal section through a second embodiment of the incubator according to the invention;

FIG. 4a shows a cross section of a variant a, along the line IV-IV in FIG. 3;

FIG. 4b shows a cross section of a variant b, along the line IV-IV in FIG. 3;

FIG. 5 shows a cross section along the line V-V in FIG. 3;

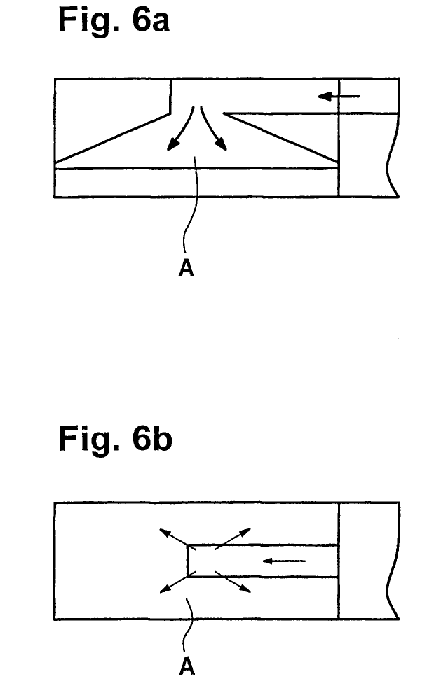

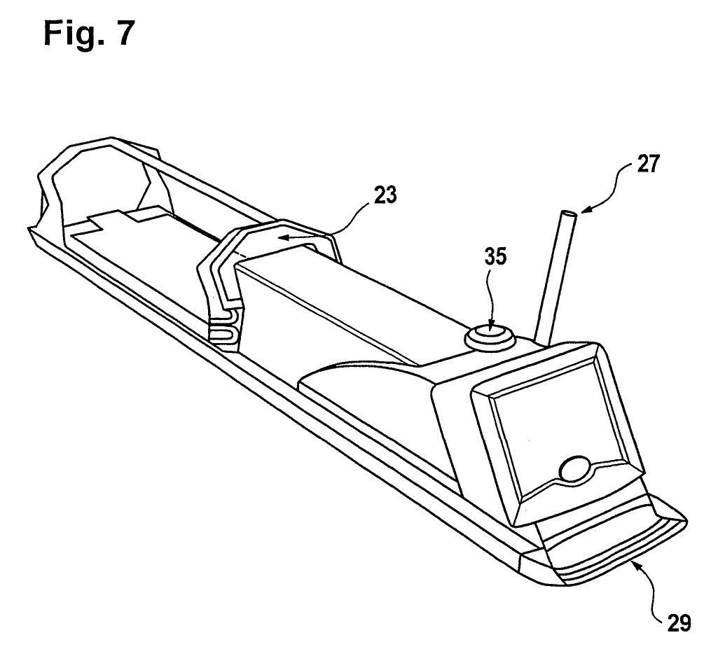

FIG. 6a shows a cross section of the variant a in FIG. 4a, along the line VI-VI-in FIG. 3;

FIG. 6b shows a cross section of the variant b in FIG. 4b, along the line VI-VI in FIG. 3;

FIG. 7 shows, in a perspective view, a third embodiment of the incubator according to the invention; and

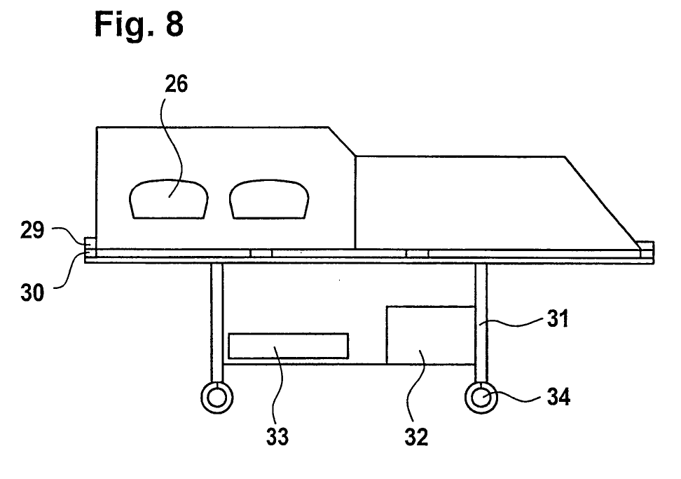

FIG. 8 shows a side view of the incubator placed on a trolley.

The incubator according to the invention shown in FIG. 1 has a patient-receiving space 1 which can be closed off by a hood 2 indicated with broken lines. The hood 2 has a double wall which, in addition to protecting against radiation losses, also protects the patient from the high noise level of the tomograph. To reduce the heat losses when the hood is open, four small hatches 26 (FIG. 8) are integrated into the hood, and access to the patient is possible through these hatches. The supply and control part 3 is situated at one end of the patient-receiving space 1. One or more coils 4 for receiving the signals for the NMRI tomography are also provided in the patient space 1, and, at the other end of the patient space 1, there is a hatch 8 for introduction and positioning of the coils 4. The patient lies on a support surface 5. The patient can also be observed through the transparent hatch 8 during the examination in the tomograph.

FIG. 2 is a diagrammatic representation showing the structure of the incubator and the arrangement of the individual components. Situated below the receiving space 1 there is an air delivery unit 6 which is supplied with air from a part 7. Part 9 is an operating panel and the control unit, and connections for electrical power supply and if necessary for oxygen are provided on the part 10.

FIGS. 3 through 5 show a slightly different embodiment which is distinguished from the embodiment in FIG. 1 primarily through the outer geometry of the incubator. A motor 11 drives a fan 12 which ensures air circulation in the direction of the arrows. The air is passed across a heating/humidifying device 13 and a sensing device 14 which measures temperature and air humidity. On the basis of the corresponding signals, the incubator is then regulated with the aid of a microprocessor 15. The air which is circulated is blown into the stabilizing space A under the support surface 5 (FIGS. 3 and 6) as is indicated in FIG. 4a, and laterally via a corresponding wall 17 into the patient space. FIG. 4b shows another possible solution in which the air from the stabilizing space A is blown in through the gaps 16 on both longitudinal sides of the patient space and two cylinders of air are formed. Through the gap 16 under the wall 17, the overpressure in the stabilizing space is generated for the necessary flow speed needed to create the cylindrical flow 18 in the patient space 1. The air then passes back into the air delivery part 7 and is blown back in again. The air delivery part 7 shown diagrammatically is designed as a Venturi tube at whose narrowest cross section the suction opening for fresh air 19 through the filter 20 is arranged. As is indicated by the arrow 19 in FIG. 5, fresh air is continuously suctioned off and, if necessary, oxygen added via a filter 20 in order to replenish the air, while the used air escapes through openings (not shown), for example in the area of the cover 4 which is made of transparent plastic. Part 9 contains the operating panel and the control and monitoring devices, while part 10 contains the connections for electrical power and, if appropriate, gas.

The coil appropriate to the examination method and to the purpose of the latter is introduced through the hatch 8 into the patient space The cable connecting the coil to the tomograph is routed through the opening 24 in the hatch 8. Infusion lines, anesthesia lines and measurement cables can also be routed through the opening 24 in the end face.

The SpO₂ sensor (cable and sensor not shown) can be attached at 25 and routed through the opening 24 to the patient. The measurement is effected via optical waveguides in order to rule out disturbances for the NMRI tomograph.

FIG. 7 shows another embodiment in which an additional window 23 is provided at one end face of the receiving space 1. A rod 27, for attachment of infusion lines, and handgrips 29 are also provided. The handgrips at the same time serve as an interface for attaching the appliance to a trolley 28. FIG. 8 shows the structure of the MR-compatible trolley 28 consisting of gas supply 33, interruption-free power supply 32 and spring suspension 31. The wheels 34 can be steered and fixed and are as large as possible in order to compensate for irregularities of the floor. The mount 30 ensures a secure connection between incubator and trolley 28 during transport.

1. An incubator for newborn and premature patients which can be introduced into the magnetic field of an NMRI tomograph, with devices (6, 7, 11, 12, 20) for delivery and circulation of fresh air and a drive mechanism for these devices, and with devices (4, 7, 9, 10, 11, 12, 13, 14, 15) for heating and humidifying the air, for regulating the temperature of said air, and for examining the patient, said devices (7, 9, 10, 11) being driven electrically and being arranged integrally on the incubator, and the air flowing into the patient space (1) at one or both long sides in such a way that one or two cylindrical air movements (18) are created in the patient space, and the air being suctioned off at the center of one end face.

2. The incubator as claimed in claim 1, characterized in that the air is delivered through a channel (6) below the support surface (5) for the patients.

3. The incubator as claimed in claim 1 or 2, characterized in that it has devices (20) for delivery of oxygen.

4. The incubator as claimed in one of claims 1 through 3, characterized in that it has devices (14, 15) for regulating the humidity and/or the oxygen concentration of the air delivered to the patient.

5. The incubator as claimed in one of claims 1 through 4, characterized in that the measurement coil(s) (4) for the NMRI tomography is (are) arranged in the patient space.

6. The incubator as claimed in claim 5, characterized in that the measurement coil(s) (4) is (are) adjustable relative to the patient.

7. The incubator as claimed in one of claims 1 through 6, characterized in that it has devices (25) for oxygen saturation measurement.

8. The incubator as claimed in one of claims 1 through 7, characterized in that it has devices for regulating the air temperature.

9. The incubator as claimed in one of claims 1 through 8, characterized in that the air is circulated by means of an electric motor (11) and a fan (12).

10. The incubator as claimed in one of claims 1 through 9, characterized in that it is controlled by a microprocessor.

11. The incubator as claimed in one of claims 1 through 10, characterized in that the end face of the patient space is provided with passages (24) for ventilation lines, anesthesia lines and infusion lines and for other lines and for signal cables of the measurement coils (4).

12. The incubator as claimed in one of claims 1 through 11, characterized in that the patient space (1) has a transparent hood (2) to permit observation of the patient.

13. The incubator as claimed in one of claims 0.1 through 12, characterized in that the operating panel (9) has digital displays and control knobs for setting the desired values.

14. The incubator as claimed in one of claims 1 through 13, characterized in that it is provided with a trolley (28) onto which it can be placed.

15. The incubator as claimed in one of claims 1 through 14, characterized in that the underpressure for fresh air intake is generated by a Venturi tube.

16. The incubator as claimed in one of claims 1 through 15, characterized in that it has an additional window (27) on that end face of the patient-receiving space (1) remote from the hatch (8).

17. The incubator as claimed in one of claims 1 through 16, characterized in that the coil(s) (4) can be fitted and replaced via one end face (8), without the patient having to be moved.

18. The incubator as claimed in one of claims 1 through 17, characterized in that the trolley (28) with current supply and gas supply is MR-compatible.

19. The incubator as claimed in one of claims 1 through 18, characterized in that the hood (2) is designed with two walls for sound insulation.
